(19) United States
(12) Patent Application Publication
(10) Pub. No.: US 2005/0206778 A1
(43) Pub. Date: Sep. 22, 2005

(54) DIGITAL CAMERA CAPABLE OF AUTO-DETECTING WHETHER TO BE STABLE

(76) Inventor: Shan-Wen Chang, Chang-Hua Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,762

(22) Filed: Aug. 2, 2004

(30) Foreign Application Priority Data
Mar. 17, 2004 (TW) 093107162

(51) Int. Cl. H04N 5/225

(52) U.S. Cl. 348/373

(57) ABSTRACT

A digital camera capable of detecting whether to be stable is provided. The digital camera includes a housing, a lens formed on the housing for inputting light, a photosensor for sensing the inputted light, an image generator for generating an image based on the sensed light, and a trigger disposed on the housing for generating a trigger signal while the housing is fixed. The digital camera is able to adjusting its operation as the housing is fixed.

### BACKGROUND OF INVENTION

1. Field of the Invention

The present invention relates to a digital camera, and more specifically, to a digital camera capable of auto-detecting whether to be stable.

2. Description of the Prior Art

As the information industry progresses, information-related products are increasingly used in daily life and conventional analog products are gradually being replaced by digital products. Take the digital camera for example; conventional film cameras utilize chemicals on a film to record images, which can only be viewed after development, moreover, if a user wants to take pictures with special effects, they are required to be skillful in controlling the stop (aperture), shutter speed, as well as lens selection and film development. This can be inconvenient for an amateur. By contrast, digital cameras convert images into digital signals using a photosensor and directly store them in a memory device. Digital cameras can also be connected to a computer system and store images on its hard disk drive. The images can then be viewed on a screen or printed on a printer. In addition, the user can further process the images recorded by the digital camera using image processing software to produce special effects, which previously could only be realized by a professional photographer with a conventional optical camera, or perhaps even then could not be readily achieved using conventional means.

If intending to take pictures in the dark or other low-light environments, the user has to enlarge the aperture or extend the exposure period so that the digital camera receives enough light. However, for an entry-level digital camera to be used to good effect in the dark, enlarging the diaphragm is not enough, generally extending the exposure period for several seconds is also required. But, during the exposure period, the digital camera must be in a fixed state, i.e. static, without the slightest movement, so as to prevent blurring of the captured image. In other words, a fixed state of the digital camera is required for the duration of long exposure periods. Therefore, taking pictures in the dark is difficult for the non-professional user without the assistance of auxiliary tools. Hence, it is an important issue for the digital camera to detect whether to be in a fixed state and to adjust its operation during the fixed state period.

### SUMMARY OF INVENTION

It is therefore a primary objective of the present invention to provide a digital camera capable of auto-detecting whether it is in a fixed state and adjusting its exposure period accordingly.

According to the claimed invention, a digital camera capable of detecting whether to be stable comprises a housing, a lens formed on the housing for inputting light, a photosensor for sensing the inputted light, an image generator for generating image based on the sensed light, and a trigger disposed on the housing for generating a trigger signal while the housing is fixed.

According to the claimed invention, an image-capturing system capable of detecting whether to be stable comprises a digital camera and a tripod. The digital camera comprises a housing, a lens formed on the housing for inputting light, a photosensor for sensing the inputted light, an image generator for generating an image based on the sensed light; and a trigger disposed on the housing for generating a trigger signal while the housing is fixed. The tripod is used for fixing the digital camera and comprises a trigger end for triggering the trigger of the digital camera for generating a trigger signal as the tripod is engaged with the digital camera.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a digital camera according to the present invention.

FIG. 2 is a functional block diagram of digital camera of FIG. 1.

FIG. 3 is a cross-sectional view of the digital camera shown in FIG. 1.

FIG. 4 is a bottom-view of the digital camera shown in FIG. 1.

### DETAILED DESCRIPTION

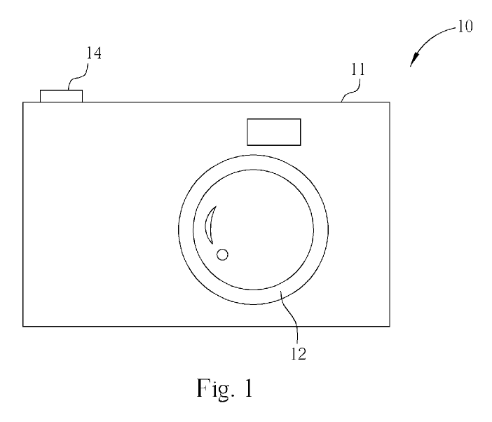

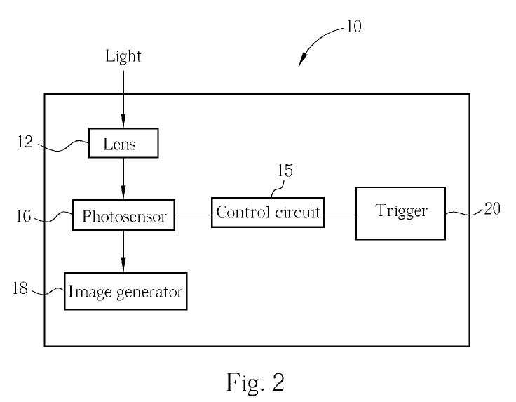

Please refer to FIG. 1 and FIG. 2. FIG. 1 shows a digital camera 10 and FIG. 2 is a functional block diagram of digital camera 10 according to the present invention. The digital camera 10 comprises a housing 11, a lens 12 on the housing 11 for inputting light, a shutter button 14 to be pressed for taking pictures, a photosensor 16 disposed within the housing 11 for sensing light from the lens 12, an image generator 18 disposed within the housing 11 and coupled to the photosensor 16 for transforming the sensed light into image signals, a trigger 20 disposed on the housing 11 for generating triggering signals while the housing 11 is fixed. In addition, a control circuit 15 is used for controlling the operation of the digital camera 10. The control circuit 15 can be a hardware circuit or program code stored in a memory. The photosensor 16 can be a charge-coupled device (CCD) or a CMOS photosensor.

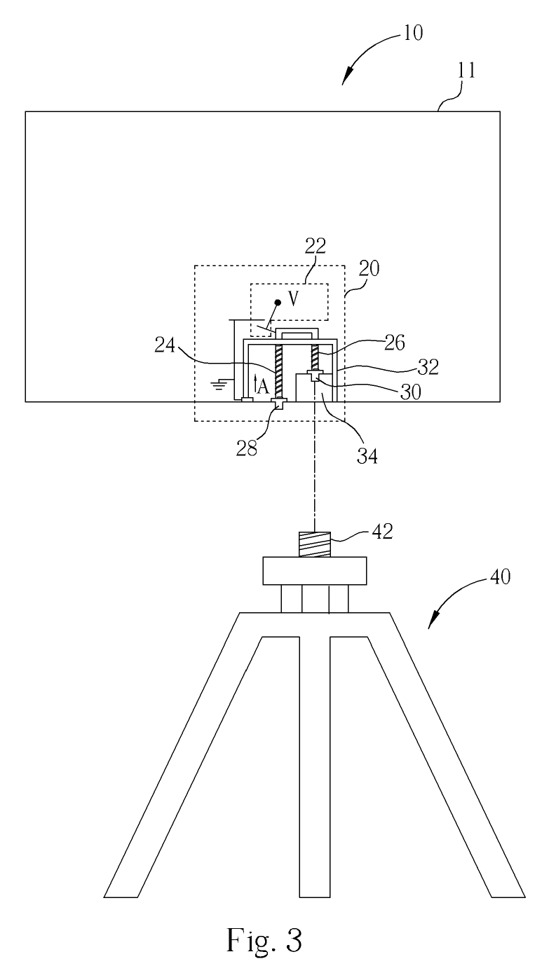

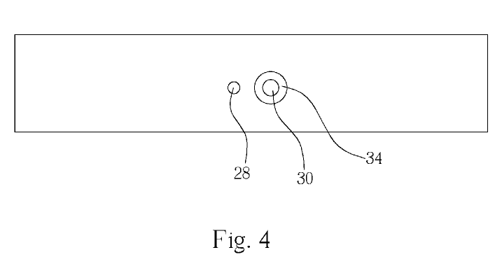

Please refer to FIGS. 3 and 4. FIG. 3 is a cross-sectional view of the digital camera 10 shown in FIG. 1. FIG. 4 is a bottom-view of the digital camera 10 shown in FIG. 1. The trigger 20 comprises a switch 22, a first spring 24, a second spring 26, a first movable rod 28, a second movable rod 30 and a supporting base 32. Both the first spring 24 and the second spring 26 can be substituted for other elastic elements. Part of the first movable rod 28 extends out of the housing 11 of the digital camera 10 while no force is applied on it. The second movable rod 30 is disposed within a recess 34 of the housing 11. In this embodiment, the first movable rod 28 is formed together with the second movable rod 30. Alternatively, the first movable rod 28 and the second movable rod 30 are also disposed independently.

When a force (in the direction of arrow A) is applied on the first movable rod 28, (e.g. the digital camera 10 is positioned on a flat surface such as a table), the first movable rod 28 is pushed toward the switch 22 to trigger a voltage V. When the applied force is removed, the first movable rod 28 will return due to a resilience from the first spring 24 coupled to the supporting base 32. In other words, a triggering signal (i.e. the voltage V) is generated as the digital camera 10 is in fixed state, that is, fixed to a tripod or other device with the purpose of alleviating ‘camera shake’ or movement during image capture. At this moment, the first movable rod 28 triggers the switch 22 to generate a triggering signal (i.e. voltage V) and the control circuit 15 detects the triggering signal in order to determine that the digital camera 10 is fixed. When the digital camera 10 is removed from the flat surface, the first movable rod 28 returns to its starting position due to the action of the first spring 24 coupled with the supporting base 32, the first movable rod 28 disengages from the switch 22 causing the triggering signal to be terminated. In this way, the control circuit 15 determines that the digital camera 10 is not in a fixed state, that is, subject to the limitations of hand-held operation with respect to movement of the camera during image capture.

The digital camera 10 also comprises a recess 34 by which the digital camera 10 is fixed to the tripod 40. When the trigger end 42 of the tripod 40 is inserted into the recess 34, the second movable rod 30 is pushed, again in a direction A, to trigger the switch 22. The control circuit 15 of the digital camera 10 again detects the voltage V in order to determine that the digital camera 10 is in a fixed condition. When the tripod 40 is removed from the digital camera 10, the second movable rod 30 returns due to the action of the second spring 26 coupled with the supporting base 32, causing the triggering signal to be terminated. In this way, the control circuit 15 determines whether or not the digital camera 10 is in a fixed state.

In another embodiment, the trigger 20 can be a specific button or any other devices having a switch function. The user is able to trigger such a device (for example, by pressing the specific button), and the control circuit 15 will adjust the digital camera 10 as for a fixed state.

Please continue referring to FIG. 2. When the fixed state of the digital camera 10 is determined, the control circuit 15 adjusts an exposure period of the photosensor 16 to be extended. For example, if intending to take pictures in the dark or other environments were ambient light levels are not high enough to allow hand-held operation, the user can position the digital camera 10 either on a flat surface thus actuating the the first movable rod 28, or on a tripod 40 thus actuating the second movable rod 30, to generate a triggering signal. The photosensor 16 automatically extends the exposure period while the triggering signal is present, returning exposure settings to those compatible with hand-held operation when the digital camera 10 is no longer fixed on a flat surface or tripod.

Compared to prior art, the present invention digital camera provides a trigger for determining whether the digital camera is in a fixed state. When the digital camera is in fixed state, an exposure period of the digital camera can be extended. In this way, even in the dark or any insufficient-light environment, the user can utilize the digital camera positioned on a flat surface, or fixed on a tripod or otherwise by triggering a specific button to extend its exposure period, and not have to worry about taking bad quality pictures in the dark.

Those skilled in the art will readily observe that numerous modifications and alterations of the device may be made while retaining the teachings of the invention. Accordingly, the above disclosure should be construed as limited only by the metes and bounds of the appended claims.

1. A digital camera for detecting whether to be stable comprising:
a housing;
a lens formed on the housing for inputting light;
a photosensor for sensing the inputted light;
an image generator for generating an image based on the sensed light; and
a trigger, disposed on the housing, for generating a trigger signal while the housing is fixed.

2. The digital camera of claim 1, wherein the trigger comprises:
a movable rod for triggering a switch to generate a trigger signal while a force is applied; and
an elastic member for returning the movable rod to stop the triggering of the switch, while the force is not applied on the movable rod.

3. The digital camera of claim 2, wherein the movable rod is extended out of the housing while the force is applied, but is pushed into the housing while the force is not applied.

4. The digital camera of claim 2, wherein the movable rod is positioned within a recess on the housing.

5. The digital camera of claim 1, wherein an exposure period of the photosensor is prolonged while the trigger signal from the trigger is received.

6. The digital camera of claim 1, wherein the photosensor is a charge-coupled device (CCD) or a CMOS photosensor.

7. An image-capturing system for detecting whether to be stable comprising:
a digital camera comprising:
a housing;
a lens formed on the housing for inputting light;
a photosensor for sensing the inputted light;
an image generator for generating an image based on the sensed light;
a trigger, disposed on the housing, for generating a trigger signal while the housing is fixed; and
a tripod for fixing the digital camera comprising:
a trigger end, for triggering the trigger of the digital camera for generating a trigger signal as the tripod is engaged with the digital camera.

8. The image-capturing system of claim 7, wherein the trigger comprises:
a movable rod for triggering a switch to generate a trigger signal while a force is applied; and
an elastic member for returning the movable rod to stop the triggering of the switch, while the force is not applied on the movable rod.

9. The image-capturing system of claim 8, wherein the movable rod is positioned within a recess on the housing.

10. The image-capturing system of claim 7, wherein an exposure period of the photosensor is prolonged while the trigger signal from the trigger is received.

11. The image-capturing system of claim 7, wherein the photosensor is a charge-coupled device (CCD) or a CMOS photosensor.
